(19) United States
(12) Patent Application Publication
(10) Pub. No.: US 2020/0176134 A1
(43) Pub. Date: Jun. 4, 2020

(54) Method for Improving ICF Target Implosion Characteristics

(71) Applicants: Robert O. Hunter, JR., Aspen, CO (US); Eric W. Cornell, Colorado Springs, CO (US)

(72) Inventors: Robert O. Hunter, JR., Aspen, CO (US); Eric W. Cornell, Colorado Springs, CO (US)

(73) Assignee: Innoven Energy LLC, Colorado Springs, CO (US)

(21) Appl. No.: 16/658,915

(22) Filed: Oct. 21, 2019

Related U.S. Application Data
(60) Provisional application No. 62/748,826, filed on Oct. 22, 2018.

(51) Int. Cl. G21B 1/19; G21B 1/03

(52) U.S. Cl. CPC G21B 1/19; G21B 1/03

(57) ABSTRACT

In a system and method for favorably affecting the Rayleigh-Taylor growth on the interface between the fuel and shell regions of an ICF target. One may increase the ratio of the tritium content to the deuterium content of the fuel or decrease the ratio of the density of the shell to the density of the fuel region. By proper configuration of the ratio between the fuel and shell regions, the Rayleigh-Taylor growth may become more stabilized. This invention would make target manufacturing much simpler and less constrictive, which would in turn decrease the cost.

### CROSS-REFERENCE TO RELATED APPLICATIONS

This application claims the benefit of U.S. Provisional Application No. 62/748,826, filed on Oct. 22, 2018, which is incorporated herein by reference.

### BACKGROUND

Inertial Confinement Fusion (“ICF”) is a process by which energy is produced by nuclear fusion reactions. The fuel pellet, generally called the target, is conventionally a spherical device which contains fuel for the fusion process. Various ways of driving and imploding the target have been utilized and considered (lasers, ion beams, etc.). These drives transfer energy to the target which then implodes and ignites the fuel. If the fuel is sufficiently heated and compressed, a self-sustaining fusion reaction occurs, wherein the fuel self-heats and produces energy from the fusion reaction.

If the target is to be useful for energy production, it must output more energy than the amount of energy needed to drive the implosion. The amount of energy required to drive the ICF target may be quite high as very high temperatures and densities are required to initiate fusion reactions. Also, the amount of energy needed to drive the target must be physically and economically achievable.

The conventional approach to ICF target design is exemplified by the Department of

Energy's program, NIF (National Ignition Facility). NIF target designs, as described in Lindl, “The Physics Basis for Ignition Using Indirect Drive Targets on the National Ignition Facility”, consists of a mostly plastic or beryllium ablator region which surrounds a cryogenic DT ice, and a central void which is filled with very low density DT gas. The target is then placed in a cylindrical hohlraum. The entire target assembly (hohlraum and target) are then placed in the target chamber, where a 192-beamline laser delivers up to 1.8 MJ of energy to the hohlraum. The hohlraum then converts the energy to x-rays which then ablate the ablator region, and by the reactive force drives the DT shell inward. This ablation process may take a very long time in comparison to the hydrodynamic motion of the target material. Due to this long timescale NIF hohlraums must have very large laser entrance holes. As the temperature of the hohlraum rises, the hohlraum material will be ablated and thereby begin to close these holes. If the holes close or become too small, the laser light will not be able to enter the hohlraum. One effect of having these large holes is that radiation is then allowed to escape the hohlraum and that energy then becomes unusable by target. Another effect of a long laser pulse is that although the hohlraum walls are fairly reflective to radiation, a significant portion of the laser energy is lost to the heating of the hohlraum walls. This means NIF targets are unable to efficiently use the energy from the laser.

Since the time scale of the laser pulse length must be long for this ablation process, the target and/or hohlraum may move during the laser pulse. If this happens there may be increased non-uniformity of the energy deposition on the target's surface. This increased non-uniformity may lead to increased Rayleigh-Taylor instability growth at the shell/fuel interface and ignition failure.

However, NIF targets have, up to now, never ignited. The areal density (ρr) of the fuel and the temperature of the fuel has, to date, fallen short of the 0.3 g/cm² and 10 keV they believe they require. It is not clear why the NIF targets have not achieved ignition, but it may be due to lower than expected shell velocities and greater than expected Rayleigh-Taylor instability growth which may be due to low fall lines.

Although NIF targets utilize a DT shell, gold shells have been considered by Lackner and Colgate. High Z shells have the effect of trapping the radiation in the DT core, thereby allowing the radiation field to reach its equilibrium blackbody spectrum and lowering ignition temperatures to about 2.5 keV.

ICF has been hampered for the last many decades by stability and symmetry considerations. Lackner and Colgate proposed using high-Z shells and they realized the advantage of the low ignition temperature that would occur therein. However, the ICF community largely rejected high-Z shells on the grounds that the mix of the high-Z material with the fuel would tend to quench any of the reactivity of the fuel.

In most ICF (inertial confinement fusion) targets a shell is used to compress and heat fuel. The shell then needs to contain the fuel until ignition occurs and runaway burn begins. NIF, as described in Haan, Physics of Plasmas 18, 051001 (2011), uses a DT ice shell which is formed during the implosion by a series of shocks, these shocks increase the density of the DT and drive the material inward, subsequently igniting DT gas at the core. High Z shells such as gold have been discussed (Lackner, 11^{th} International Workshop on Laser Interaction high Z shell may have advantages. One advantage is that by containing radiation in the fuel region, ignition temperatures are reduced.

For ICF, one target approach is a shell imploded by a variety of means (ion beams, laser, another shell, etc.) that transfers a portion of its energy to the fusion fuel inside of the shell. Both compression and heating of the fuel ensure, and, if the losses to the shell are sufficiently small, the fuel ignites.

Stability and symmetry of shell/fuel interfaces have been a major issue for ICF. As the shell decelerates Rayleigh-Taylor growth on the shell interface can prevent ignition of the fuel in the core of the target. It is desirable to prevent any instabilities from growing during the deceleration of the shell.

Rayleigh-Taylor instability occurs when a fluid with higher density (ρ₁) is placed over a fluid with lower density (ρ₂) in a gravitational field. When the interface is disturbed, the heavier fluid is driven into the lighter one. The Atwood number (Aₜ) is a quantity used to describe density profile. At is a dimensionless density ratio defined as

$${A}_{t} = \frac{{ρ}_{1} - {ρ}_{2}}{{ρ}_{1} + {ρ}_{2}}$$

wherein ρ₁ is the density of heavier fluids and ρ₂ is the density of the lighter fluids. The Rayleigh-Taylor instability grows as the Atwood number grows.

Unless otherwise indicated herein, the materials described in this section are not prior art to the claims in this application and are not admitted to being prior art by inclusion in this section.

### SUMMARY

Generally, an equimolar mixture of deuterium and tritium is used for the fuel region of an ICF target. However, by increasing the ratio of the tritium content of the fuel to the deuterium content, you favorably affect the Rayleigh-Taylor growth on the interface between the shell and fuel regions. By proper configuration of the ratio of the density between the fuel and shell regions, the Rayleigh-Taylor growth may become more stabilized.

Another aspect of this invention is to decrease the density of the shell. In order to decrease the density of the shell a variety of materials could be used for the shell instead of a high Z shell, such as tungsten. One could use a medium Z material or low Z material for the shell, one could even mix a low Z material with a high Z material or a low Z material with a medium Z material. For example, by adding carbon, copper or some other low Z material to the high Z shell, the density of the shell will be reduced.

### DRAWINGS

FIG. 1 shows an ICF target with a shell surrounding a fuel region.

FIG. 2 shows a definition of the fall line parameter.

### SPECIFICATION

This present invention describes various techniques to reduce the Rayleigh-Taylor growth on the shell/fuel interface. Of course, the invention may have application to many other ways to increase the density of the fuel. Co-pending application “Dynamic Mode Compensation,” by Robert O. Hunter, Jr. and Eric Cornell (to be filed), describes various techniques how one could enhance the noise properties of an ICF target by timing multiple oscillations such that their sum is minimized. This invention would make target manufacturing much simpler and less constrictive, which would in turn decrease the cost.

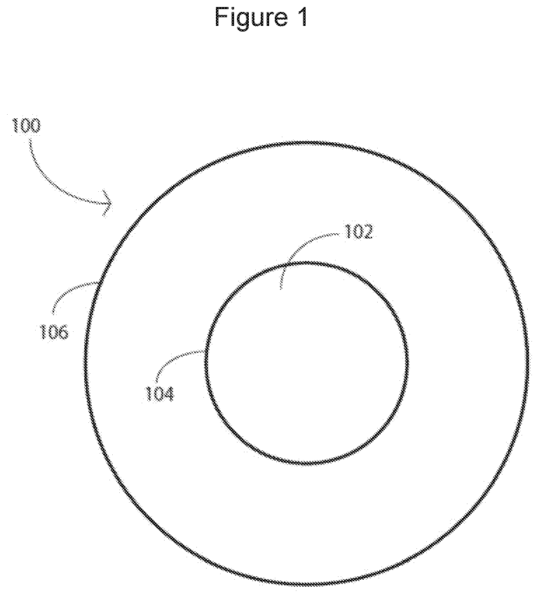

FIG. 1 (not to scale) shows a target assembly 100 comprising an ICF target 106. ICF target 106 includes a shell 104 which surrounds a fuel region 102. Fuel region 102 could be filled with various types of fusion fuel such as: pure deuterium, lithium deuteride, lithium tritide, or any other fusion fuel or combination of fuels. The shell 104 may implode, if sufficiently driven by ways known in the art, such as ablation of an outer ablator region (not shown) or other methods known in the art. This inward motion of the shell 104 may launch a shock into the fuel region 102 which may sufficiently heat the fuel region 102, and simultaneously, the shell 104 may compress the fuel region 102 and cause it to ignite and burn a significant fraction of the fuel. A shell having a high Z refers to elements of atomic number greater than or equal to 49, medium Z refers to elements of atomic number 6-48 and low Z refers to elements of atomic number less than or equal to 5. Fuel region may be filled with equimolar deuterium and tritium (DT).

The fuel region 102 could consist of equimolar mixture of deuterium and tritium. In one embodiment, the tritium content of the fuel region 102 is increased. By increasing the fraction of tritium, the density of the fuel is then increased. Table 1 below depicts various conditions when using an equimolar mixture of deuterium and tritium, 20% more tritium or 50% more tritium. It is advantageous to increase the remaining kinetic energy of the shell, fall line and net rate of change in heat due to fuel temperature while reducing the ignition time, and convergence. The percentage of remaining kinetic energy in the shell (KE_{Shell}) is defined as the quotient of remaining Kinetic Energy (KE_{Left}) by maximum Kinetic Energy (KE_{Max}) when mass-averaged fuel temperature is 2.5 keV as seen below:

$${KE}_{Shell} = \frac{{KE}_{Left}}{{KE}_{Max}}$$

Another parameter is defined as the quotient of change in fuel temperature (\dot{T}) including the PdV work done by the inward moving shell by change in fuel temperature due to reactivity only (\dot{T}ᵣ) as seen below:

$$\frac{T}{{T}_{r}}$$

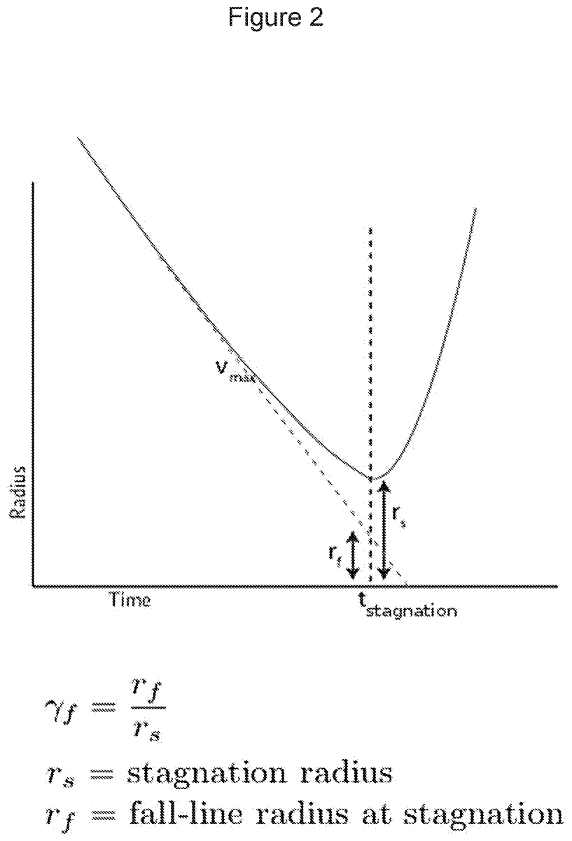

The fall line parameter (γf) is defined as the radius at which the shell/fuel interface would have been ignoring effects of deceleration divided by the radius of the interface including the effects of deceleration at the time of stagnation of the shell/fuel interface (see FIG. 2).

$${γ}_{f} = \frac{{r}_{f}}{{r}_{s}}$$

wherein r_{f}=fall-line radius at stagnation and rₛ=stagnation radius. The ignition time is defined as a time when mass-averaged fuel temperature is 2.5 keV. The shell convergence (C) is defined as the initial inner shell radius over the inner shell radius at stagnation

C=rᵢ/rₛ

TABLE 1

| | Kinetic Energy | | Fall | Ignition | Shell |
|---|---|---|---|---|---|
| | Left (%) | \dot{T}/\dot{T}ᵣ | Line | Time(s) | Convergence |
| Equimolar | 52.68 | 2.025 | 0.264 | 9.78e−9 | 5.687 |
| +20% (#/cc) | 53.47 | 2.128 | 0.280 | 9.77e−9 | 5.655 |
| +50% (#/cc) | 55.04 | 2.197 | 0.281 | 9.76e−9 | 5.586 |

In ICF, conditions as outlined above in Table 1 are achieved when imploding a capsule containing a combination of fusion fuels. The fuel region 102 is compressed to densities 10³ times larger than the original fuel density and its temperature is raised to above 10⁷ degrees Celsius. Margin parameters such as kinetic energy left in the shell,

$$\frac{T}{{T}_{r}} ,$$

fall line, etc. show how far away the target is from failure. Having a large amount of kinetic energy left in the shell at ignition ensures the shell is moving inward when the fuel ignites. If the change in temperature of fuel exceeds the change due only to the reactivity, the strength of initiation of the fuel is increased. If the target ignites earlier then there is less time for the instabilities on the shell/fuel interface to grow, as shown above by a higher fall line. At ignition time, the outer radius of the fuel region 102 is a small fraction its initial radius. The ratio of the shell convergence is the ratio of the initial radius of a certain interface to the radius of the same interface at stagnation. Ideally, smaller shell convergence will reduce instability growth. Increasing the tritium content of the fuel too greatly will begin to diminish the yield of the target and may prevent ignition entirely.

As the shell is driven inward, it compresses and heats the fuel, as well as launching a shock into the fuel. This shock reflects off the origin and returns to the shell. When the reflected shock hits the shell, the shell decelerates. This deceleration will cause Rayleigh-Taylor growth on the shell fuel interface. In order to reverse this effect, one can time the implosion such that the density in the fuel becomes greater than that of the shell. This will cause any growth that has formed to effectively be reversed.

Further, if the inner shell surface area grows too large, increased thermal losses to the shell will reduce the target's yield or prevent ignition entirely. Simply increasing the tritium content of the fuel region 102 may not increase the ratio of the density of the fuel to the density of the shell 104 greatly. It may be desirable to decrease the density of the shell. In order to decrease the density of the shell a variety of different materials could be used for the shell instead of a high Z material, such as tungsten. One could also use a medium Z material or low Z material for the shell, one could even use a mixture of various materials such as a low Z material with a high Z material or a low Z material with a medium Z material. For example, by adding carbon, copper or some other low Z material to the high Z shell, the density of the shell will be reduced.

Embodiments of this invention discussed in this application were designed using numerical simulations and hand calculations. This design process necessarily involves making approximations and assumptions. The description of the operation and characteristics of the embodiments presented above is intended to be prophetic, and to aid the reader in understanding the various considerations involved in designing embodiments, and is not to be interpreted as an exact description of how embodiments will perform, an exact description of how various modifications will change the characteristics of an embodiment, nor as the results of actual real-world experiments.

Additionally, the set of embodiments discussed in this application is intended to be exemplary only, and not an exhaustive list of all possible variants of the invention. Certain features discussed as part of separate embodiments may be combined into a single embodiment. Additionally, embodiments may make use of various features known in the art but not specified explicitly in this application.

Embodiments can be scaled-up and scaled-down in size, and relative proportions of components within embodiments can be changed as well. The range of values of any parameter (e.g. size, thickness, density, mass, etc.) of any component of an embodiment of this invention, or of entire embodiments, spanned by the exemplary embodiments in this application should not be construed as a limit on the maximum or minimum value of that parameter for other embodiments, unless specifically described as such.

While advantages and characteristics of certain embodiments are mentioned, this should not be interpreted as a requirement that all embodiments display these advantages or characteristics. The previous description provides embodiments only, and is not intended to limit the scope, applicability, or configuration of the disclosure. Rather, the previous description of the embodiments will provide those skilled in the art with an enabling description for implementing one or more embodiments. It is understood that various changes may be made in the function and arrangement of elements without departing from the spirit and scope of the invention. Several embodiments were described herein, and while various features are ascribed to different embodiments, it should be appreciated that the features described with respect to one embodiment may be incorporated within other embodiments as well. By the same token, however, no single feature or features of any described embodiment should be considered essential to every embodiment of the invention, as other embodiments of the invention may omit such features.

Specific details are given in the previous description to provide a thorough understanding of the embodiments. However, it will be understood by one of ordinary skill in the art that the embodiments may be practiced without these specific details. While detailed descriptions of one or more embodiments have been given above, various alternatives, modifications, and equivalents will be apparent to those skilled in the art without varying from the spirit of the invention. Moreover, except where clearly inappropriate or otherwise expressly noted it should be assumed that the features, devices and/or components of different embodiments may be substituted and/or combined. Thus, the above description should not be taken as limiting the scope of the invention.

1. A method for improving ICF target implosion, comprising:
constructing an ICF target, wherein said ICF target comprises:
a fusion fuel mixture in a central region; and
a shell region surrounding said central region, wherein said shell region receives a fusion fuel mixture;
increasing the kinetic energy of said shell region, increasing the quotient of change in fuel temperature, increasing the fall line of the shell region while reducing the ignition time and shell convergence when imploding said ICF target.

2. The method of claim 1, further comprising: adjusting the density of the central region and/or shell region.

3. The method of claim 2, further comprising: increasing the density of the fusion fuel mixture in the central region.

4. The method of claim 3, wherein the fusion fuel mixture comprises a mixture of tritium, lithium and/or deuterium.

5. The method of claim 4, further comprising: increasing the density of the fusion fuel mixture in the central region by adding a high Z material such as tritium.

6. The method of claim 5, further comprising: decreasing the density of the shell region. The method of claim 6, further comprising: adding a low Z material to the shell region.

8. The method of claim 7, further comprising adding a low Z material such as carbon and/or copper to the shell region.

9. The method of claim 2, further comprising: decreasing the density of the shell region.

10. The method of claim 9, further comprising: adding a low Z material to the shell region.

11. The method of claim 10, further comprising adding a low Z material such as carbon and/or copper to the shell region.
